(19) United States
(12) Patent Application Publication
(10) Pub. No.: US 2019/0331756 A1
(43) Pub. Date: Oct. 31, 2019

(54) APPARATUS AND METHOD FOR RISLEY PRISM BASED STAR TRACKER AND CELESTIAL NAVIGATION SYSTEM

(71) Applicant: Honeywell International Inc., Morris Plains, NJ (US)

(72) Inventors: Matthew Edward Lewis Jungwirth, Golden Valley, MN (US); Wes Hawkinson, Chanhassen, MN (US)

(73) Assignee: Honeywell International Inc., Morris Plains, NJ (US)

(21) Appl. No.: 15/962,723

(22) Filed: Apr. 25, 2018

(51) Int. Cl. G01S 3/786; G01C 21/02; G01S 3/781; G02B 26/08; G02B 27/00

(52) U.S. Cl. CPC G01S 3/786; G01C 21/025; G02B 27/0081; G02B 26/0891; G01S 3/781

(57) ABSTRACT

A system is provided. The system comprises: a rotational beam system; an optical detector system, including a Risley prism system, coupled to the rotational beam system; wherein the rotational beam system is configured to azimuthally rotate the optical detector system around an axis at a fixed altitude angle; and wherein the at least one Risley prism system is configured to change the field of view of the optical detector system.

### BACKGROUND

Risley prisms comprise at least a pair of wedge-shaped prisms that enable variable beam deflection. Thus, Risley prisms can be used for light beam steering. The wedge-shaped prisms can, e.g., be fabricated from glass.

U.S. patent application Ser. No. 15/604,501, filed on May 24, 2017 discloses using a Risley prism as light beam steering mechanism. U.S. patent application Ser. No. 15/604,501 is hereby incorporated by reference in its entirety herein. A Risley prism provides desirable performance, but with a limited field of regard.

Further, typical star tracker and celestial navigation systems require collection optics that collect light over as broad a bandwidth as possible. However, conventional broadband collection optics suffer from lateral chromatic aberration that smears images, thereby decreasing resolution.

### SUMMARY

A system is provided. The system comprises: a rotational beam system; an optical detector system, including a Risley prism system, coupled to the rotational beam system; wherein the rotational beam system is configured to azimuthally rotate the optical detector system around an axis at a fixed altitude angle; and wherein the at least one Risley prism system is configured to change the field of view of the optical detector system.

### BRIEF DESCRIPTION OF THE DRAWINGS

Features of the present invention will become apparent to those skilled in the art from the following description with reference to the drawings. Understanding that the drawings depict only typical embodiments and are not therefore to be considered limiting in scope, the invention will be described with additional specificity and detail through the use of the accompanying drawings, in which:

FIG. 1 illustrates a block diagram of one embodiment of a star tracker system or celestial navigation system utilizing an improved optical detection and beam steering system;

FIG. 2 illustrates a block diagram of one embodiment of a system including the improved optical detection and beam steering system;

FIG. 3 illustrates a block diagram of one embodiment of an optical detector system;

FIG. 4 illustrates one embodiment of a Risley prism including two pairs of achromatic wedge prisms;

FIG. 5 illustrates one embodiment of a freeform objective lens; and

FIG. 6 illustrates a flow diagram of one embodiment of a method for implementing a Risley prism based star tracker or celestial navigation system according to the present invention.

### DETAILED DESCRIPTION

In the following detailed description, embodiments are described in sufficient detail to enable those skilled in the art to practice the invention. It is to be understood that other embodiments may be utilized without departing from the scope of the invention. The following detailed description is, therefore, not to be taken in a limiting sense.

In one embodiment, a combination of an optical steering mechanism using a Risley prism and a mechanical steering mechanism is proposed. The combination has a desirable size, weight, power and cost (SWaP-C), and extends the field of regard. Specifically, the size, weight, power, complexity, reliability, and cost of the present invention are lower than for a conventional dual axis optical steering mechanisms using gimbals. Further, the combination has a larger field of regard in comparison to a Risley prism alone.

Further, the field of regard of the combination may be at least five times the field of regard of a Risley prism. The mechanical steering mechanism used to increase the field of regard can be a single, inexpensive, low fidelity mechanism, such as a low fidelity stepper motor; the Risley prism can provide required precision optical steering so that the combination can have an accuracy of about one half to one degree.

In another embodiment, which can be employed independently of the prior embodiment, a modified objective lens comprising at least three freeform mirrors is proposed. Because mirrors are used, the modified objective lens does not suffer from lateral chromatic aberration. Further, the implementation of the modified objective lens reduces SWaP.

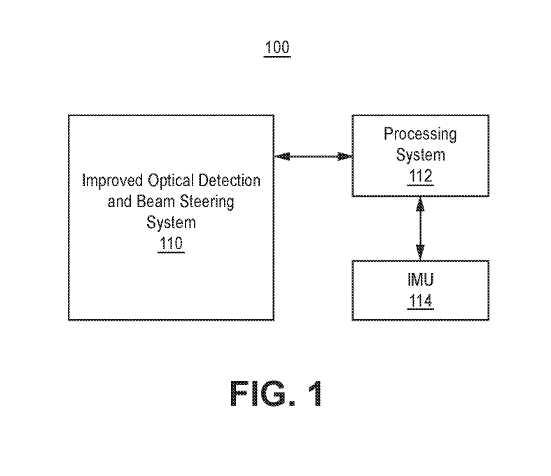

FIG. 1 illustrates a block diagram of one embodiment of a star tracker system or celestial navigation system utilizing an improved optical detection and beam steering system (improved star tracker system or celestial navigation system) 100. The improved star tracker system or celestial navigation system 100 includes a processing system 112 coupled to an optical detection and improved beam steering system 110 and an inertial measurement unit (IMU) 114. The IMU 114 comprises at least one gyroscope and at least one accelerometer.

The IMU 114 facilitates efficiently determining attitude to determine where the optical detection and improved beam steering system 110 is pointed, and/or to provide continuous navigation information. However, other embodiments of an improved star tracker system or celestial navigation system 100 can be implemented without using an IMU 114.

In one embodiment, the processing system 112 is a state machine, e.g. comprising processing circuitry coupled to memory circuitry. The processing circuitry includes one or more microprocessors, microcontrollers, digital signal processors, application specific integrated circuits, and/or gate arrays. The memory circuitry includes one or more dynamic random access memory (DRAM), Flash memory, read only memory (ROM), magnetic memory (hard drive), and/or optical memory (e.g. an optical reader and an optical disc). The processing system 112 is configured to control the movement of the optical detection and improved beam steering system 110.

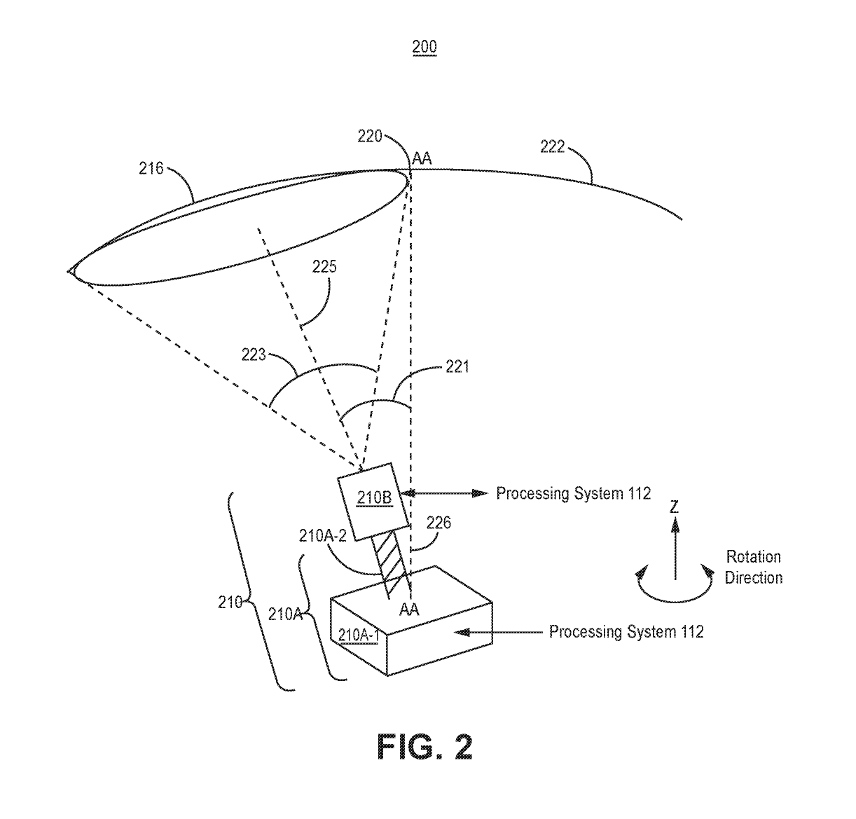

FIG. 2 illustrates a block diagram of one embodiment of a system including the improved optical detection and beam steering system 200. In one embodiment, the improved optical detection and beam steering system 210 allows for increased field of regard while diminishing mechanical motion. In another, separate embodiment, the improved optical detection and beam steering system 210 facilitates diminished volume improved optical detection and beam steering system 210 and at least one component therein.

The illustrated improved optical detection and beam steering system 210 comprises a rotational beam system 210A and an optical detector system 210B. The rotational beam system 210A is configured to azimuthally rotate the optical detector system 210B around an axis AA at a fixed altitude angle 221 with respect to axis AA. Axis AA projects from the center of rotation 226 of the beam 210A-2 to the zenith 220, and, e.g. is parallel to the illustrated z-axis. The zenith 220 is a mid-point in a field of regard 222 of an environment 216 capable of being imaged by the optical detection and improved beam steering system 210. The environment 216, for example, is the sky or outer space.

The rotational beam system 210A comprises a first actuator 210A-1 and a beam 210A-2. The first actuator 210A-1 may be a stepper motor, e.g. implemented by an electric motor, a piezoelectric actuator, and/or any other type of actuator. The first actuator 210A-1 rotates the beam 210A-2 around axis AA, e.g. in increments of degrees(s) or a fraction of a degree. The beam 210A-2 may be made from metal, plastic, ceramic, metamaterials, and/or any other material, and is preferably rigid.

The processing system 112 is coupled to the rotational beam system 210A, e.g. the first actuator 210A-1. The processing system 112 is configured to control (e.g. through a digital and/or analog electrical circuitry) the movement of the first actuator 210A-1, and thus control the position of the optical detector system 210B. Optionally, the processing system 112 is also configured to process data detected by the optical detector system 210B, and/or to control the rotation of at least one wedge prism forming at least one Risley prism.

In one embodiment, the first actuator 210A-1 provides coarse steering, e.g. of the optical detector system and its field of view. This reduces the amount and degrees of mechanical movement, reducing complexity, power consumption, and cost of the improved optical detection and beam steering system 210 compared to a dual axis gimbal system. Note, the cost, size and power of actuator(s) for the Risley prisms are much less then for a system with gimbals. In another embodiment, the first actuator 210A-1 provides between five to thirty degrees per incremental step.

The improved optical detection and beam steering system 210 is illustrated in an environment 216. The improved optical detection and beam steering system 210 has a field of regard (FOR), e.g. 120 degrees. The optical detector system 210B has an optical axis 225. The optical detector system 210B has a field of view (FOV) 223, e.g. sixty degrees, centered on the optical axis 225; this field of view is accomplished by the subsequently described optical detector system 210B. In the illustrated example, the optical axis 225 of the optical detector system 210B is displaced by the fixed altitude angle 221 from axis AA. Optionally, the fixed altitude angle 221 is one half of the field of view of the optical detector system 210B; however, the fixed altitude angle 221 may be different, e.g. lower to allow overlap between adjacent FOVs arising from movement of the optical detector system 210B by the first actuator 210A-1. The optical detector system 210B is configured to be rotated, at the fixed altitude angle 221, three hundred and sixty degrees around axis AA. As a result, the field of view of the improved optical detection and beam steering system 210 is doubled, e.g. from sixty degrees of the optical detector system 210B alone to one hundred and twenty degrees.

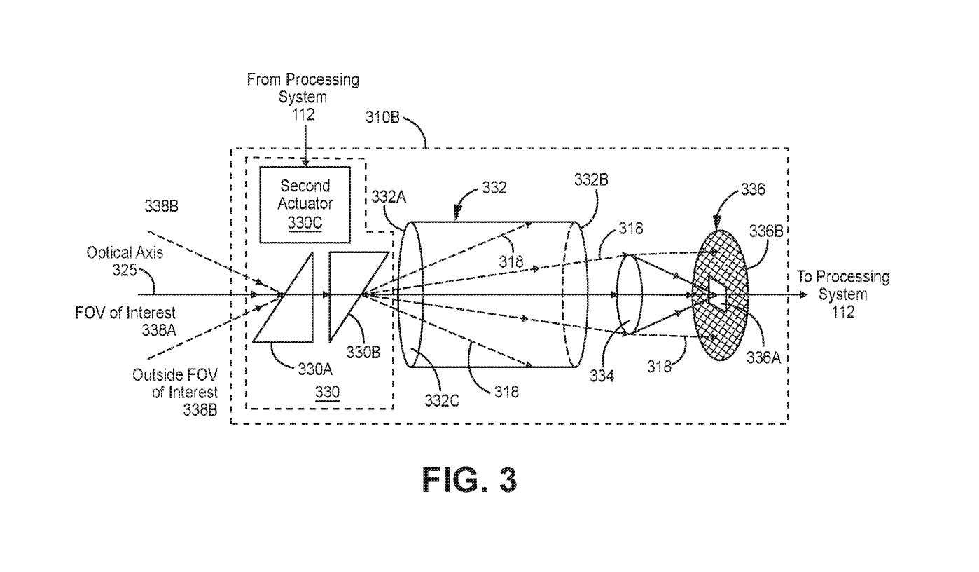

FIG. 3 illustrates a block diagram of one embodiment of an optical detector system 310B. The optical detector system can be implemented in different ways then shown in the embodiment in FIG. 3.

The optical detector system 310B includes a Risley prism system 330, an objective lens 334, and an optical detector 336. Optionally, the optical detector system 310B comprises a light shade 332, e.g. between the Risley prism system 330 and the objective lens 334.

The Risley prism system 330 is positioned along an optical axis 325 to receive an optical beam from a FOV, including at least one optical ray from a FOV of interest 338A and one or more optical rays from outside the FOV of interest 338B. The Risley prism system 330 comprises at least one Risley prism (e.g. a first wedge prism 330A, a second wedge prism 330B) and at least one second actuator (second actuator(s)) 330C, e.g. mechanically, coupled to the at least one Risley prism. In one embodiment, the second actuator(s) 330C comprise one or more motorized rotary mounts such as Newport Corporation model 8401.

In one embodiment, at least one wedge prism is rotatable by the second actuator(s) 330C, transverse to the optical axis 325, with respect to the other wedge prism by the second actuator(s) 330C. Thus, the second actuator(s) 330C are, e.g. mechanically, coupled to at least one wedge prism. The second actuator(s) 330C are electrically activated to rotate at least one of wedge prism to alter the FOV of the at least one Risley prism. By rotating the one or more of the wedge prisms, the field of view can be shifted within a larger field of regard over the course of, e.g. a one hundred and eighty degree prism rotation. The improved optical detection and beam steering system 200 can mechanically, azimuthally rotate, at the fixed altitude angle 221, the optical detector system 210B with the rotational beam system 210A by three hundred and sixty degrees around axis AA in the manner described above, and can also rotate one or more wedge prisms in the Risley prism. Thus, a field of regard of the improved optical detection and beam steering system 200 is at least five times the field of regard of the optical detector system 210B alone.

Optionally, each rotatable wedge prism of a Risley prism is rotated by at least one actuator (actuator(s)); such actuator(s) comprise the second actuator(s) 330C. The actuator(s) of a Risley prism comprise at least one electric motor and/or piezoelectric actuator. Alternatively, only one wedge prism of a pair of wedge prisms forming a Risley prism is rotated by actuator(s), e.g. second actuator(s) 330C.

The range of field of view of a Risley prism can be designed based upon the thickness, index of refraction, and prism (or apex) angle of each wedge prism in the Risley prism. Optionally, the wedge prisms can be a matched set, e.g. pair, of wedge prisms in which both wedge prisms are composed of the same material, e.g. glass. However, star trackers and celestial navigation systems detect multi-chromatic light. Therefore, optionally, some or all of wedge prisms in a Risley prism can be made from different materials (e.g. different types of glass, e.g. crown glass, flint glass, and/or chalcogenide glass) that have opposite chromatic aberrations so that the Risley prism has minimal or no chromatic aberration, e.g. lateral chromatic aberration or color.

The objective lens 334 is positioned along the optical axis 325 to receive (e.g. from the Risley prism 330, or optionally from an output end 332B of the light shade 332) optical ray(s) from the FOV of interest 338A, and any optical ray(s) that are from outside the FOV of interest 338B, e.g. and that pass through the optional light shade 332. An optical detector 336 is positioned along the optical axis 325, and includes an optical detector array 336A and a light blocker 336B that surrounds the optical detector array 336A.

The objective lens 334 receives a collimated optical signal from the Risley prism system 330 and focuses the optical signal onto the optical detector array 336A. Thus, the optical detector array 336A receives, from the objective lens 334, the optical ray(s) that are from the FOV of interest 338A. Any optical rays 318 from outside the FOV of interest 338B that pass through objective lens 334 and have smaller field angles are blocked by light blocker 336B. In one embodiment, light blocker 336B has a disc shape and is covered with a coating that absorbs light energy. The optical detector array 336A can be operatively coupled to the processing system 112, which processes, e.g. using image processing techniques, signals received from optical detector array 336A for further use by the star tracker or celestial aided inertial navigation unit. The processing system 112 also controls the first actuator 210A-1 and the second actuator(s) 330C. Thus, processing system 112 controls the field of view of the Risley prism system 330 and the optical detector system 310B, and the improved optical detection and beam steering system 210.

The optional light shade 332, having an input end 332A and an output end 332B, is positioned along the optical axis 325 and configured to receive, at input end 332A, the optical beam from the Risley prisms 330. The light shade 332 includes a hollow interior defined by an inner surface 332C, which is configured to block the one or more rays 338B that are from outside the FOV of interest and have larger field angles, as the optical beam passes through light shade 320. The ray 338A that is from the FOV of interest passes through output end 332B of light shade 320. In one embodiment, light shade 332 has a cylindrical shape, and inner surface 332C has a plurality of light absorbing baffles.

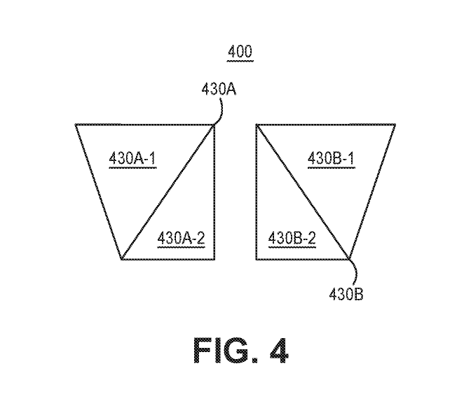

FIG. 4 illustrates one embodiment of a Risley prism including two pairs of achromatic wedge prisms (modified Risley prism) 400. The modified Risley prism 400 comprises a first pair of achromatic wedge prisms (first pair) 430A and a second pair of achromatic wedge prisms (second pair) 430B. In an alternative embodiment, the first wedge prism 330A and the second wedge prism 330B in the Risley prism system 330 can be respectively implemented by the first pair 430A and the second pair 430B.

The achromatic wedge prisms in each pair of wedge prisms can be a matched pair in which both achromatic wedge prisms are composed of the same material, e.g. glass material. However, the material used to form each achromatic wedge prism of each pair may be different. Further, both pairs of achromatic wedge prisms can be matched so that the corresponding achromatic wedge prisms of each pair are composed of the same types of material.

The achromatic wedge prisms of each pair of wedge prisms may be attached with index matching adhesive, e.g. glue, which diminishes Fresnel reflections at the surfaces of each wedge prism in contact with the adhesive. Typically, the adhesive has an index of refraction between the index of refraction of the material forming each wedge prism.

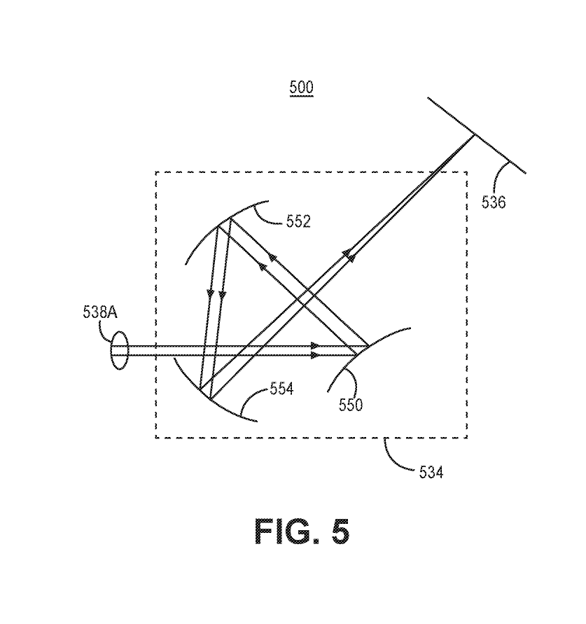

FIG. 5 illustrates one embodiment of a freeform objective lens 500. The freeform objective lens 500 means an objective lens using freeform optics to reduce the volume of the objective lens, to reduce lateral and longitudinal chromatic aberrations, and have a very broad wavelength bandwidth (e.g. the bandwidth of the optical signals received in the field of view). Freeform optics means optics with at least one freeform surface which has no translational or rotational symmetry about axes.

The freeform objective lens 500 also can improve the signal to noise ratio and image quality of the optical detector system. The freeform objective lens 500 is made from one or more freeform mirrors to eliminate chromatic aberration. The freeform objective lens can be formed in three dimensions, e.g. a cube, rather than substantially two dimensions in the axial direction as is conventional. Freeform mirrors have a smoothly varying three dimensional surface which may be random. Freeform mirrors need not have an axis of symmetry in the center of the mirror, or an axis of symmetry at all. This permits an implementation of an objective lens with a folded beam path in a reduced volume that has diminished aberrations, such as coma and astigmatism, and diffraction limited performance over a broad wavelength band. Further, the freeform objective lens 500 has a higher modulation transfer function, thus increasing the image quality and signal to noise ratio of the optical detector system 210B. Freeform mirrors are typically made with a diamond (stylus) turning manufacturing process.

The illustrated freeform objective lens 500 includes a first freeform mirror 550, a second freeform mirror 552, and a third freeform mirror 554. For purposes of illustration only, the first mirror 550 is shown as a convex mirror, and the second mirror 552 and the third mirror 554 shown as concave mirrors; however, that need not be the case as discussed above.

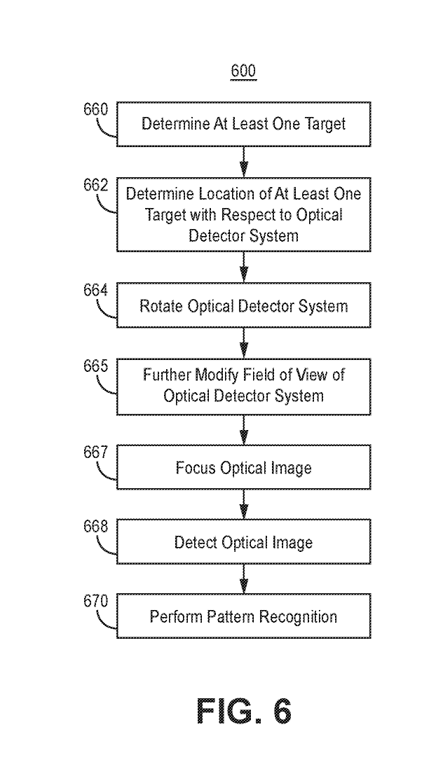

FIG. 6 illustrates a flow diagram of one embodiment of a method 600 for implementing a Risley prism based star tracker or celestial navigation system according to the present invention. To the extent the method 600 shown in FIG. 6 is described herein as being implemented in the system shown in FIGS. 1-5, it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 660, determine at least one target to detect. Each target is a known object such as a celestial object, including a star, a planet, or a satellite, in the sky or in outer space. In block 662, determine a location of the at least one target with respect to an optical detector system, e.g. using the IMU 114 and processing system 112, and/or based upon other input, e.g. from a user of the optical detector system and/or from a global navigation satellite system receiver coupled to the processing system. In block 664, rotate an optical detector system around an axis and at a fixed altitude angle with respect to the axis, so that the field of view of the optical detector system is proximate to, i.e. at or near to, a portion of an environment including the at least one target. Optionally, when rotated, the field of view of the optical detector system includes the at least one target.

Optionally, in block 665, further modify the field of view of the optical detector system by rotating at least one wedge prism in at least one Risley prism in the optical detector system so that the field of view includes the at least one target. In block 667, focusing an optical image in the field of view of the optical detector system, e.g. with an objective lens that is a freeform objective lens. In block 668, detect the optical image in the field of view of the optical detector system. The optical image includes images of the at least one target. In block 670, perform pattern recognition to identify the at least one target by comparing the detected optical image to a known pattern including the at least one target. Pattern recognition may involved pattern matching and/or machine learning techniques.

At least some of the foregoing blocks may be implemented as non-transitory program instructions stored in the storage media, such as memory circuitry of the processing system 112. At least a portion of the program instructions are read from the storage media, and executed, by the processing circuitry of the processing system 112. The program instructions are also referred to herein as “software”.

### Example Embodiments

Example 1 includes a system, comprising: a rotational beam system; an optical detector system, including a Risley prism system, coupled to the rotational beam system; wherein the rotational beam system is configured to azimuthally rotate the optical detector system around an axis at a fixed altitude angle; and wherein the at least one Risley prism system is configured to change the field of view of the optical detector system.

Example 2 includes the system of Example 1, wherein the rotational beam system comprises: an actuator; and a beam coupled to the actuator.

Example 3 includes the system of any of Examples 1-2, wherein the optical detector system further comprises: an objective lens; an optical detector; and wherein the Risley prism system comprises at least one Risley prism and at least one actuator coupled to at least one of the at least one Risley prism.

Example 4 includes the system of Example 3, wherein the objective lens is a freeform objective lens.

Example 5 includes the system of Example 4, wherein the freeform objective lens comprises at least one freeform mirror.

Example 6 includes the system of any of Examples 3-5, further comprising a light shade between the Risley prism system and the objective lens.

Example 7 includes the system of any of Examples 1-6, further comprising: a processing system coupled to the rotational beam system and the optical detection system; and an inertial measurement unit coupled to the processing system.

Example 8 includes the system of any of Examples 1-7, wherein the Risley prism system comprises a first wedge prism and a second wedge prism; and wherein at least one of the first wedge prism and the second wedge prism are coupled to at least one actuator.

Example 9 includes the system of any of Examples 1-8, wherein the Risley prism system comprises at least one Risley prism including two pairs of achromatic wedge prisms.

Example 10 includes a system, comprising: a Risley prism system; a freeform objective lens; an optical detector system; wherein the Risley prism system comprises at least one Risley prism and at least one actuator coupled to at least one of the at least one Risley prism; and wherein the Risley prism system is configured to change the field of view of the system.

Example 11 includes the system of Example 10, further comprising a light shade between the Risley prism system and the objective lens.

Example 12 includes the system of any of Examples 10-11, wherein the freeform objective lens comprises at least one freeform mirror.

Example 13 includes the system of any of Examples 10-12, further comprising a rotational beam system; wherein the Risley prism system, the freeform objective lens, and the optical detector system are coupled to the rotational beam system; and wherein the rotational beam system is configured to azimuthally rotate the optical detector system around an axis at a fixed altitude angle

Example 14 includes the system of any of Examples 10-13, further comprising: a processing system coupled to the optical detector and the Risley prism system; and an inertial measurement unit coupled to the processing system.

Example 15 includes the system of any of Examples 10-14, wherein the Risley prism system comprises at least one Risley prism including two pairs of achromatic wedge prisms.

Example 16 includes a method, comprising: determining at least one target to detect; determining a location of the at least one target with respect to an optical detector system; rotating an optical detector system around an axis and at a fixed altitude angle with respect to the axis so that a field of view of the optical detector system is proximate to a portion of an environment including the at least one target; focusing an optical image in the field of view of the optical detector system; detecting an optical image in the field of view of the optical detector system, where the optical image includes images of the at least one target; and performing pattern recognition to identify the at least one target by comparing the detected optical image to a known pattern including the at least one target.

Example 17 includes the method of Example 16, wherein determining the at least one target comprises determining at least one target that includes is least one of a star, a planet or a satellite.

Example 18 includes the method of any of Examples 16-17, wherein rotating the optical detector system comprises rotating the optical detector system so that the field of view of the optical detector system includes the at least one target.

Example 19 includes the method of any of Examples 16-18, further comprising further modifying the field of view of the optical detector system by rotating at least one wedge prism in at least one Risley prism in the optical detector system so that the field of view includes the at least one target.

Example 20 includes the method of any of Examples 16-19, wherein focusing the optical image in the field of view of the optical detector system comprises focusing the optical image in the field of view of the optical detector system with a freeform objective lens.

The present invention may be embodied in other specific forms without departing from its essential characteristics. The described embodiments are to be considered in all respects only as illustrative and not restrictive. The scope of the invention is therefore indicated by the appended claims rather than by the foregoing description. All changes that come within the meaning and range of equivalency of the claims are to be embraced within their scope.

What is claimed is:

1. A system, comprising:
a rotational beam system;
an optical detector system, including a Risley prism system, coupled to the rotational beam system;
wherein the rotational beam system is configured to azimuthally rotate the optical detector system around an axis at a fixed altitude angle; and
wherein the at least one Risley prism system is configured to change the field of view of the optical detector system.

2. The system of claim 1, wherein the rotational beam system comprises:
an actuator; and
a beam coupled to the actuator.

3. The system of claim 1, wherein the optical detector system further comprises:
an objective lens;
an optical detector; and
wherein the Risley prism system comprises at least one Risley prism and at least one actuator coupled to at least one of the at least one Risley prism.

4. The system of claim 3, wherein the objective lens is a freeform objective lens.

5. The system of claim 4, wherein the freeform objective lens comprises at least one freeform mirror.

6. The system of claim 3, further comprising a light shade between the Risley prism system and the objective lens.

7. The system of claim 1, further comprising:
a processing system coupled to the rotational beam system and the optical detection system; and
an inertial measurement unit coupled to the processing system.

8. The system of claim 1, wherein the Risley prism system comprises a first wedge prism and a second wedge prism; and
wherein at least one of the first wedge prism and the second wedge prism are coupled to at least one actuator.

9. The system of claim 1, wherein the Risley prism system comprises at least one Risley prism including two pairs of achromatic wedge prisms.

10. A system, comprising:
a Risley prism system;
a freeform objective lens;
an optical detector system;
wherein the Risley prism system comprises at least one Risley prism and at least one actuator coupled to at least one of the at least one Risley prism; and
wherein the Risley prism system is configured to change the field of view of the system.

11. The system of claim 10, further comprising a light shade between the Risley prism system and the objective lens.

12. The system of claim 10, wherein the freeform objective lens comprises at least one freeform mirror.

13. The system of claim 10, further comprising a rotational beam system;
wherein the Risley prism system, the freeform objective lens, and the optical detector system are coupled to the rotational beam system; and
wherein the rotational beam system is configured to azimuthally rotate the optical detector system around an axis at a fixed altitude angle

14. The system of claim 10, further comprising:
a processing system coupled to the optical detector and the Risley prism system; and
an inertial measurement unit coupled to the processing system.

15. The system of claim 10, wherein the Risley prism system comprises at least one Risley prism including two pairs of achromatic wedge prisms.

16. A method, comprising:
determining at least one target to detect;
determining a location of the at least one target with respect to an optical detector system;
rotating an optical detector system around an axis and at a fixed altitude angle with respect to the axis so that a field of view of the optical detector system is proximate to a portion of an environment including the at least one target;
focusing an optical image in the field of view of the optical detector system;
detecting an optical image in the field of view of the optical detector system, where the optical image includes images of the at least one target; and
performing pattern recognition to identify the at least one target by comparing the detected optical image to a known pattern including the at least one target.

17. The method of claim 16, wherein determining the at least one target comprises determining at least one target that includes is least one of a star, a planet or a satellite.

18. The method of claim 16, wherein rotating the optical detector system comprises rotating the optical detector system so that the field of view of the optical detector system includes the at least one target.

19. The method of claim 16, further comprising further modifying the field of view of the optical detector system by rotating at least one wedge prism in at least one Risley prism in the optical detector system so that the field of view includes the at least one target.

20. The method of claim 16, wherein focusing the optical image in the field of view of the optical detector system comprises focusing the optical image in the field of view of the optical detector system with a freeform objective lens.
